(19) United States
(12) Patent Application Publication
(10) Pub. No.: US 2020/0189459 A1
(43) Pub. Date: Jun. 18, 2020

(54) METHOD AND SYSTEM FOR ASSESSING ERRANT THREAT DETECTION

(71) Applicant: GM GLOBAL TECHNOLOGY OPERATIONS LLC, DETROIT, MI (US)

(72) Inventors: Lawrence A. Bush, Shelby Township, MI (US); Zachariah E. Tyree, Shelby Township, MI (US)

(21) Appl. No.: 16/219,439

(22) Filed: Dec. 13, 2018

(51) Int. Cl. B60Q 9/00; G01S 13/04; G01S 13/93; G06K 9/00; G06K 9/03; G06K 9/62

(52) U.S. Cl. CPC B60Q 9/00; G01S 13/04; G01S 13/931; G06K 9/00791; G06K 9/03; B60R 11/04; G06K 9/00845; G06K 9/6261; G01S 2013/9367; G01S 2013/9357; G06K 9/6297

(57) ABSTRACT

A threat assessment system and method of assessing errant threat detection. The method, in one implementation, involves receiving a detection estimation from a driver of the vehicle or an object detection sensor of the vehicle, obtaining an analysis environmental camera image from a camera on the vehicle, generating a predictive saliency distribution based on the analysis environmental camera image, comparing the detection estimation received from the driver of the vehicle or the object detection sensor of the vehicle with the predictive saliency distribution, and determining a deviation between the detection estimation and the predictive saliency distribution.

### INTRODUCTION

The field of technology relates to vehicle threat detection, and more particularly, to assessing errant threat detection.

Promoting driver attentiveness and focusing is desirable, yet false positives and over-reporting of threats or potential threats can inundate a driver. It is advantageous to alert drivers of potential threats; however, it can be more advantageous to alert drivers of potential threats of which they are not aware or otherwise not alerted to. This involves reconciling threat detection methods with assessing whether the threat is being perceived, either by the driver, or one or more object detection sensors, on the vehicle.

### SUMMARY

According to one embodiment, there is provided a method of assessing errant threat detection for a vehicle, comprising the steps of: receiving a detection estimation from a driver of the vehicle or an object detection sensor of the vehicle; obtaining an analysis environmental camera image from a camera on the vehicle; generating a predictive saliency distribution based on the analysis environmental camera image; comparing the detection estimation received from the driver of the vehicle or the object detection sensor of the vehicle with the predictive saliency distribution; and determining a deviation between the detection estimation and the predictive saliency distribution.

According to various embodiments, this method may further include any one of the following features or any technically-feasible combination of some or all of these features:
the predictive saliency distribution is a spatiotemporal camera based predictive distribution of threats, and relating to threats, that other drivers would be likely to visually attend;
obtaining a plurality of initial environmental camera images before the analysis environmental camera image;
performing an optical flow analysis of the plurality of initial environmental images and using results of the optical flow analysis to generate the predictive saliency distribution;
performing a semantic segmentation of the analysis environmental camera image and using both the results of the optical flow analysis and the semantic segmentation to generate the predictive saliency distribution;
the detection estimation is a glance aim point estimation received from a driver of the vehicle;
the glance aim point estimation involves determining a glance track probability distribution;
a 2D hidden Markov model (HMM) is used to determine the glance track probability distribution;
creating a homographic projection to reconcile the glance track probability distribution and the analysis environmental camera image;
the divergence is a glance-saliency divergence between the glance track probability distribution and the predictive salience distribution;
comparing the glance-saliency divergence to a glance-saliency divergence threshold and alerting the driver if the glance-saliency divergence is greater than the glance-saliency divergence threshold;
the detection estimation is a threat weighted occupancy probability distribution from one or more sensor readings from the object detection sensor of the vehicle;
the object detection sensor is a radar sensor or a lidar sensor;
using a Markov random field model to estimate an occupancy grid to develop the threat weighted occupancy probability distribution;
creating a homographic projection to reconcile the threat weighted occupancy probability distribution and the analysis environmental camera image;
the divergence is a sensor-saliency divergence between the threat weighted occupancy probability distribution and the predictive salience distribution; and/or
comparing the sensor-saliency divergence to a sensor-saliency divergence threshold and alerting the driver if the sensor-saliency divergence is greater than the sensor-saliency divergence threshold.

According to another embodiment, there is provided a method of assessing errant threat detection for a vehicle, comprising the steps of: determining a glance track probability distribution to estimate a glance aim point of a driver of the vehicle; obtaining an analysis environmental camera image from a camera on the vehicle; determining a glance-saliency divergence between a predictive saliency distribution that corresponds with the analysis environmental camera image and the glance track probability distribution; comparing the glance-saliency divergence to a glance-saliency divergence threshold; and alerting the driver if the glance-saliency divergence is greater than the glance-saliency divergence threshold.

According to yet another embodiment, there is provided a threat assessment system, comprising: a camera module; an object detection sensor; and an electronic control unit (ECU) operably coupled to the camera module and the object detection sensor, wherein the ECU is configured to receive a detection estimation from a driver of the vehicle or the object detection sensor, obtain an analysis environmental camera image from the camera module, generate a predictive saliency distribution based on the analysis environmental camera image; compare the detection estimation received from the driver of the vehicle or the object detection sensor with the predictive saliency distribution, and determine a deviation between the detection estimation and the predictive saliency distribution.

According to various embodiments of the system, the camera module includes a driver facing camera and an environmental camera.

### BRIEF DESCRIPTION OF THE DRAWINGS

One or more embodiments will hereinafter be described in conjunction with the appended drawings, wherein like designations denote like elements, and wherein:

FIG. 1 is a block diagram depicting an embodiment of a threat detection system that is capable of utilizing the methods disclosed herein;

FIG. 2 illustrates a still-shot of a predictive saliency distribution in accordance with one embodiment;

FIG. 3 illustrates another still-shot of two predictive saliency distributions in accordance with one embodiment;

FIG. 4 is a flowchart of an embodiment of a method of assessing errant threat detection, described within the context of the threat detection system of FIG. 1; and

FIG. 5 is a flowchart of a more particular embodiment of a method of assessing errant threat detection, described within the context of the threat detection system of FIG. 1; and

FIG. 6 is a flowchart of another more particular embodiment of assessing errant threat detection, described within the context of the threat detection system of FIG. 1.

### DETAILED DESCRIPTION

The system and methods described below involve noticing inattentive driver behaviors and aiding focusing. To accomplish this, a predictive saliency distribution can be used to estimate or assess potential threats to the vehicle. The predictive saliency distribution is a spatiotemporal camera based predictive distribution of threats, and relating to threats, that other drivers would be likely to visually attend. The predictive saliency distribution is dynamic and changes as the vehicle moves and/or encounters various objects. The predictive saliency distribution can be compared with the glance patterns of the driver and/or sensor readings from one or more object detection sensors on the vehicle. Blending glance patterns with the saliency distribution can be used to aide driver focus, as an alert can be provided to the driver if there is a particular divergence between the glance patterns and the saliency distribution. Additionally, blending sensor detection with the saliency distribution can also help aide driver focus for incident avoidance.

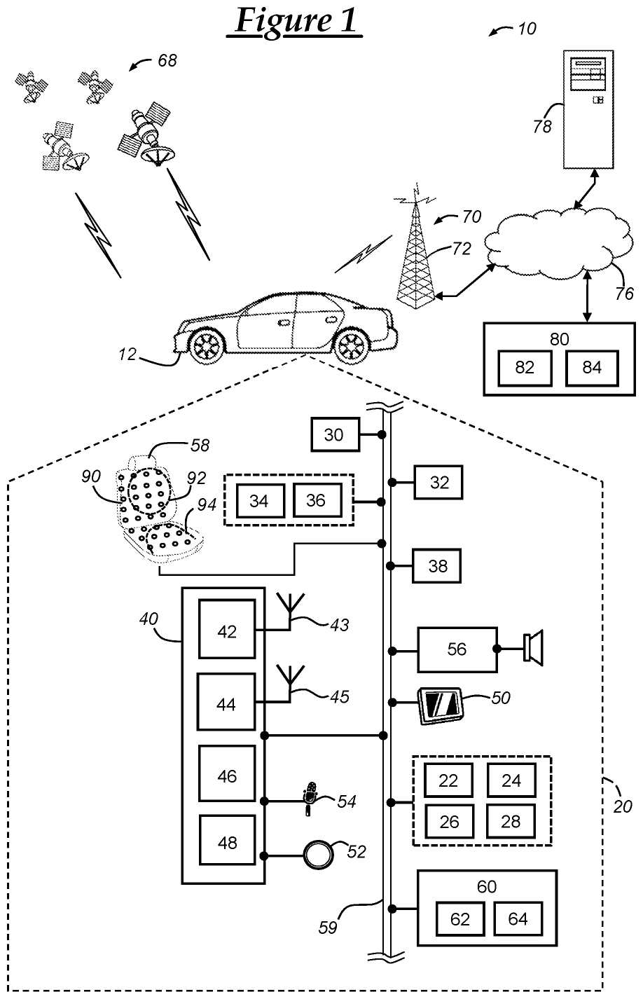

With reference to FIG. 1, there is shown an operating environment that comprises a threat assessment system 10 which can be used to implement the methods disclosed herein. Threat assessment system 10 generally includes sensors 22-32, a forward facing camera 34, a driver facing camera 36, a GNSS receiver 38, a wireless communications device 40, other vehicle system modules (VSMs) 50-58, and an electronic control unit (ECU) 60. Threat assessment system 10 further includes a constellation of global navigation satellite system (GNSS) satellites 68, one or more wireless carrier systems 70, a land communications network 76, a computer or server 78, and a backend facility 80. It should be understood that the disclosed method can be used with any number of different systems and is not specifically limited to the operating environment shown here. The following paragraphs provide a brief overview of one such threat assessment system 10; however, other systems not shown here could employ the disclosed methods as well. It should also be appreciated that the threat assessment system 10 and methods may be used with any type of vehicle, including traditional passenger vehicles, sports utility vehicles (SUVs), cross-over vehicles, trucks, vans, buses, recreational vehicles (RVs), motorcycles, etc. These are merely some of the possible applications, as the threat assessment system and methods described herein are not limited to the exemplary embodiment shown in FIG. 1 and could be implemented with any number of different vehicles.

Any number of different sensors, components, devices, modules, systems, etc. may provide the threat assessment system 10 with information, data and/or other input. These include, for example, the components shown in FIG. 1, as well as others that are known in the art but are not shown here. It should be appreciated that the host vehicle sensors, cameras, object detection sensors, GNSS receiver, ECU, HMIs, as well as any other component that is a part of and/or is used by the threat assessment system 10 may be embodied in hardware, software, firmware or some combination thereof. These components may directly sense or measure the conditions for which they are provided, or they may indirectly evaluate such conditions based on information provided by other sensors, components, devices, modules, systems, etc. Furthermore, these components may be directly coupled to a controller or ECU 60, indirectly coupled via other electronic devices, a vehicle communications bus, network, etc., or coupled according to some other arrangement known in the art. These components may be integrated within another vehicle component, device, module, system, etc. (e.g., sensors that are already a part of an active safety system, a traction control system (TCS), an electronic stability control (ESC) system, an antilock brake system (ABS), etc.), they may be stand-alone components (as schematically shown in FIG. 1), or they may be provided according to some other arrangement. In some instances, multiple sensors might be employed to sense a single parameter (e.g., for providing redundancy). It should be appreciated that the foregoing scenarios represent only some of the possibilities, as any type of suitable arrangement or architecture may be used to carry out the methods described herein.

The host vehicle sensors 22-30 may include any type of sensing or other component that provides the present systems and methods with data or information regarding the performance, state and/or condition of the vehicle 12. Information from the host vehicle sensors 22-30 may be used to extrapolate information regarding upcoming objects or threats (e.g., whether the host vehicle 12 is accelerating toward a potential threat, road conditions, etc.). According to the non-limiting example shown in FIG. 1, the host vehicle sensors include host vehicle speed sensors 22-28 and a dynamic sensor unit 30. The host vehicle speed sensors 22-28 provide the system 10 with speed readings that are indicative of the rotational speed of the wheels, and hence the overall speed or velocity of the vehicle. In one embodiment, individual wheel speed sensors 22-28 are coupled to each of the vehicle's four wheels and separately provide speed readings indicating the rotational velocity of the corresponding wheel (e.g., by counting pulses on one or more rotating wheel(s)). Skilled artisans will appreciate that these sensors may operate according to optical, electromagnetic or other technologies, and that speed sensors 22-28 are not limited to any particular speed sensor type. In another embodiment, the speed sensors could be coupled to certain parts of the vehicle, such as an output shaft of the transmission or behind the speedometer, and produce speed readings from these measurements. It is also possible to derive or calculate speed readings from acceleration readings (skilled artisans appreciate the relationship between velocity and acceleration readings). In another embodiment, speed sensors 22-28 determine vehicle speed relative to the ground by directing radar, laser and/or other signals towards the ground and analyzing the reflected signals, or by employing feedback from a navigation unit that has Global Positioning System (GPS) capabilities (e.g., GNSS receiver 38). It is possible for the speed readings to be provided to the system 10 by some other module, subsystem, system, etc., like a powertrain or engine control module or a brake control module. Any other known speed sensing techniques may be used instead.

Dynamic sensor unit 30 provides the system with dynamic readings that pertain to the various dynamic conditions occurring within the vehicle, such as acceleration and yaw rate. Unit 30 may include any combination of sensors or sensing elements that detect or measure vehicle dynamics, and it may be packaged separately or in a single unit. According to one exemplary embodiment, dynamic sensor unit 30 is an integrated inertial measurement unit (IMU) that includes a yaw rate sensor, a lateral acceleration sensor, and a longitudinal acceleration sensor. Some examples of suitable acceleration sensor types include micro-electromechanical system (MEMS) type sensors and tuning fork-type sensors, although any type of acceleration sensor may be used. Depending on the particular needs of the system, the acceleration sensors may be single- or multi-axis sensors, may detect acceleration and/or deceleration, may detect the magnitude and/or the direction of the acceleration as a vector quantity, may sense or measure acceleration directly, may calculate or deduce acceleration from other readings like vehicle speed readings, and/or may provide the g-force acceleration, to cite a few possibilities. Although dynamic sensor unit 30 is shown as a separate unit, it is possible for this unit or elements thereof to be integrated into some other unit, device, module, system, etc.

Object detection sensor 32 provides the system 10 with sensor readings and object data that pertain to nearby vehicles, pedestrians, or other objects or threats surrounding the vehicle 12. The object sensor readings can be representative of the presence, position, velocity, and/or acceleration of nearby vehicles, as well as of nearby pedestrians and other objects. This data may be absolute in nature (e.g., an object velocity or acceleration relative to ground or some other frame of reference) or the data may be relative in nature (e.g., an object velocity or acceleration relative to the host vehicle). While only one object detection sensor 32 is schematically illustrated, in some embodiments, multiple object detection sensors are included to monitor various positions around the vehicle 12. Each of the object detection sensors may be a single sensor or a combination of sensors, and may include one or more radar devices, laser devices, lidar devices, ultrasound devices, vision devices, other known devices or combinations thereof. In an advantageous embodiment, the object detection sensor 32 is a radar sensor or a lidar sensor. In a further advantageous embodiment, the object detection sensor 32 is a penetrating radar sensor.

Of course, other vehicle sensors that provide information as to the state of the vehicle 12 could be used in addition to or in lieu of those described above. Some potential examples include a V2X communication unit to provide information relating to other vehicles, infrastructure, or pedestrians (e.g., V2V, V2I, or V2P); an ambient sensor to provide readings relating to outside weather events or other environmental events; steering angle sensors; accelerator and brake pedal sensors; stability sensors; and gear selection sensors, to cite just a few. Further, some implementations of the present systems and methods may not have all of the vehicle sensors or other components described herein.

An environmental camera 34 and a driving facing camera 36 can be used to provide environmental camera images and information relating to glance patterns of the driver of vehicle 12, respectively. In an advantageous embodiment, the environmental camera 34 is a forward-facing camera that obtains camera images of the environment ahead of the vehicle 12. However, it is possible for the camera 34 to face other directions and for the methods to assess error threats in other surrounding areas of the vehicle (e.g., with a backup camera when the vehicle 12 is in reverse). The environmental camera 34 and/or the driving facing camera 36 may be connected directly or indirectly to the ECU 60 for processing input from the cameras. Cameras 34, 36 may be of any suitable camera type (e.g., charge coupled device (CCD), complementary metal oxide semiconductor (CMOS), etc.) and may have any suitable lens known in the art so that it is not limited to any particular type, brand or model. In one particular embodiment, the cameras 34, 36 are both mounted to a pair of glasses worn by the driver of the vehicle 12. In another embodiment, the cameras 34, 36 are integrated in a single camera module mounted near or on the windshield or rearview mirror of the vehicle 12. In some embodiments, only one camera may be used to obtain both the environmental camera images and the driver glance images. Other camera configurations are certainly possible, such as mounting the environmental camera 34 on the exterior of vehicle 12, and mounting the driver facing camera 36 near the rear view mirror, to cite a few examples. Some non-limiting examples of potential embodiments or features that may be used with cameras 34, 36 include: infrared LEDs for night vision; wide angle or fish eye lenses; surface mount, flush mount, license mount, or side mount cameras; stereoscopic arrangements with multiple cameras; cameras integrated into tail lights, brake lights, or other components at the rear end of the vehicle; and wired or wireless cameras, to cite a few possibilities. Adaptations of the methods described herein to account for various camera types and/or positions for cameras 34, 36 can be accomplished offline before running the methodology in real-time or almost-real time.

Cameras 34, 36 may provide a plurality of images (e.g., derived from streaming video or other captured video) to ECU 60, which may then process the images to develop a predictive saliency distribution and a glance track probability distribution, as detailed further below. In one embodiment, the cameras 34, 36 continuously transmit video data to ECU 60 while the vehicle's ignition or primary propulsion system is on or activated. The video data may be interlaced or progressive scan type video data or interlaced scan type video data to ECU 60. The ECU 60 may then decode, convert, or otherwise process the video data such that the video encoded in the data may be adequately processed and used by the various methods described herein. Other image processing may be carried out by the processor of the ECU 60 or other processing device in vehicle 12.

As will be discussed more below, through use of image processing techniques, the processor may recognize certain objects, such as an upcoming threat to the vehicle 12 that the driver may not be paying attention to. In one embodiment, ECU 60 may use image processing software that may distinguish certain objects in the captured images and, through analysis of a series of images, possibly in combination with information from one or more vehicle sensors such as the sensor 32, may determine a position, distance, velocity and/or acceleration of such distinguished threats or objects with respect to vehicle 12.

Any of the devices 22-36 may be stand-alone, as illustrated in FIG. 1, or they may be incorporated or included within some other device, unit or module (e.g., some of the sensors 22-28 could be packaged in an inertial measurement unit (IMU), the camera 34 could be integrated with an active safety system, etc.). Furthermore, any of the devices 22-36 may be dedicated, as depicted in FIG. 1, or they may be part of or shared by other systems or sub-systems in the vehicle (e.g., the camera 34 and/or some of the sensors 22-30 could be part of a semi-autonomous driving system). The video input and/or sensor input devices 22-36 may be directly provided to ECU 60 or indirectly provided through some other device, module and/or system, as is commonly known in the art. Accordingly, the devices 22-36 are not limited to the schematic representation in FIG. 1 or the exemplary descriptions above, nor are they limited to any particular embodiment or arrangement so long as they can be used with the method described herein.

Global navigation satellite system (GNSS) receiver 38 receives radio signals from a constellation of GNSS satellites 68. GNSS receiver 38 can be configured to comply with and/or operate according to particular regulations or laws of a given geopolitical region (e.g., country). The GNSS receiver 38 can be configured for use with various GNSS implementations, including global positioning system (GPS) for the United States, BeiDou Navigation Satellite System (BDS) for China, Global Navigation Satellite System (GLONASS) for Russia, Galileo for the European Union, and various other navigation satellite systems. For example, the GNSS receiver 38 may be a GPS receiver, which may receive GPS signals from a constellation of GPS satellites 68. And, in another example, GNSS receiver 38 can be a BDS receiver that receives a plurality of GNSS (or BDS) signals from a constellation of GNSS (or BDS) satellites 68. In either implementation, GNSS receiver 38 can include at least one processor and memory, including a non-transitory computer readable memory storing instructions (software) that are accessible by the processor for carrying out the processing performed by the receiver 38.

GNSS receiver 38 may be used to provide navigation and other position-related services to the vehicle driver. Navigation information, such as information concerning upcoming events that may impact travel, can be presented on the display 50 or can be presented verbally such as is done when supplying turn-by-turn navigation. The navigation services can be provided using a dedicated in-vehicle navigation module (which can be part of GNSS receiver 38 and/or incorporated as a part of wireless communications device 40 or other VSM), or some or all navigation services can be done via the vehicle communications device 40 (or other telematics-enabled device) installed in the vehicle, wherein the position or location information is sent to a remote location for purposes of providing the vehicle with navigation maps, map annotations (points of interest, restaurants, etc.), route calculations, and the like. The position information can be supplied to the vehicle backend facility 80 or other remote computer system, such as computer 78, for other purposes, such as fleet management and/or for training purposes in developing the predictive saliency distribution, as discussed below.

Wireless communications device 40 is capable of communicating data via short-range wireless communications (SRWC) and/or via cellular network communications through use of a cellular chipset 44, as depicted in the illustrated embodiment. In one embodiment, the wireless communications device 40 is a central vehicle computer that is used to carry out at least part of the methods discussed below. In the illustrated embodiment, wireless communications device 40 includes an SRWC circuit 42, a cellular chipset 44, a processor 46, memory 48, and antennas 43 and 45. In one embodiment, wireless communications device 40 may be a standalone module or, in other embodiments, device 40 may be incorporated or included as a part of one or more other vehicle system modules, such as a center stack module (CSM), a body control module (BCM), an infotainment module, a head unit, and/or a gateway module. In some embodiments, the device 40 can be implemented as an OEM-installed (embedded) or aftermarket device that is installed in the vehicle. In some embodiments, the wireless communications device 40 is a telematics unit (or telematics control unit) that is capable of carrying out cellular communications using one or more cellular carrier systems 70. The telematics unit can be integrated with the GNSS receiver 38 so that, for example, the GNSS receiver 38 and the wireless communications device (or telematics unit) 40 are directly connected to one another as opposed to being connected via communications bus 59.

In some embodiments, the wireless communications device 40 can be configured to communicate wirelessly according to one or more short-range wireless communications (SRWC) such as any of the Wi-Fi™, WiMAX™, Wi-Fi Direct™, other IEEE 802.11 protocols, ZigBee™, Bluetooth™, Bluetooth™ Low Energy (BLE), or near field communication (NFC). As used herein, Bluetooth™ refers to any of the Bluetooth™ technologies, such as Bluetooth Low Energy™ (BLE), Bluetooth™ 4.1, Bluetooth™ 4.2, Bluetooth™ 5.0, and other Bluetooth™ technologies that may be developed. As used herein, Wi-Fi™ or Wi-Fi™ technology refers to any of the Wi-Fi™ technologies, such as IEEE 802.11b/g/n/ac or any other IEEE 802.11 technology. The short-range wireless communication (SRWC) circuit 42 enables the wireless communications device 40 to transmit and receive SRWC signals, such as BLE signals. The SRWC circuit may allow the device 40 to connect to another SRWC device. Additionally, in some embodiments, the wireless communications device may contain a cellular chipset 44 thereby allowing the device to communicate via one or more cellular protocols, such as those used by cellular carrier system 70. In such a case, the wireless communications device becomes user equipment (UE) usable in carrying out cellular communications via cellular carrier system 70.

Wireless communications device 40 may enable vehicle 12 to be in communication with one or more remote networks (e.g., one or more networks at backend facility 80 or computers 78) via packet-switched data communication. This packet-switched data communication may be carried out through use of a non-vehicle wireless access point that is connected to a land network via a router or modem. When used for packet-switched data communication such as TCP/IP, the communications device 40 can be configured with a static IP address or can be set up to automatically receive an assigned IP address from another device on the network such as a router or from a network address server. Packet-switched data communications may also be carried out via use of a cellular network that may be accessible by the device 40. Communications device 40 may, via cellular chipset 44, communicate data over wireless carrier system 70. In such an embodiment, radio transmissions may be used to establish a communications channel, such as a voice channel and/or a data channel, with wireless carrier system 70 so that voice and/or data transmissions can be sent and received over the channel.

Processor 46 can be any type of device capable of processing electronic instructions including microprocessors, microcontrollers, host processors, controllers, vehicle communication processors, and application specific integrated circuits (ASICs). It can be a dedicated processor used only for communications device 40 or can be shared with other vehicle systems. Processor 46 executes various types of digitally-stored instructions, such as software or firmware programs stored in memory 48, which enable the device 40 to provide a wide variety of services. For instance, processor 46 can execute programs or process data to carry out at least a part of the method discussed herein. Memory 48 may be a temporary powered memory, any non-transitory computer-readable medium, or other type of memory. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives. Similar components to those previously described (processor 46 and/or memory 48, as well as SRWC circuit 42 and cellular chipset 44) can be included in another control module and/or various other VSMs that typically include such processing/storing capabilities, such as ECU 60.

The wireless communications device 40 is connected to the bus 59, and can receive sensor data from one or more vehicle sensors 22-32 and/or the cameras 34, 36 and, thereafter, the vehicle 12 can send this data (or other data derived from or based on this data) to other devices or networks, including the vehicle backend facility 80. In some embodiments, however, all or some data is processed by the ECU 60 or another module. In an advantageous embodiment, real-time or almost-real-time processing is all done via ECU 60 to avoid processing delays. Training for the methods, however, may wholly or partially be processed using computer 78 and/or backend facility (including servers 82 and databases 84).

Vehicle electronics 20 also includes a number of vehicle-user interfaces that provide vehicle occupants with a means of providing and/or receiving information, including visual display 50, pushbutton(s) 52, microphone 54, audio system 56, and/or haptic feedback device 58. As used herein, the term “vehicle-user interface” broadly includes any suitable form of electronic device, including both hardware and software components, which is located on the vehicle 12 and enables a vehicle user to communicate with or through a component of the vehicle. Vehicle-user interfaces 50-54 are also onboard vehicle sensors that can receive input from a user or other sensory information. The pushbutton(s) 52 allow manual user input into the communications device 40 to provide other data, response, or control input. Audio system 56 provides audio output to a vehicle occupant and can be a dedicated, stand-alone system or part of the primary vehicle audio system. According to the particular embodiment shown here, audio system 56 is operatively coupled to both vehicle bus 59 and an entertainment bus (not shown) and can provide AM, FM and satellite radio, CD, DVD and other multimedia functionality. This functionality can be provided in conjunction with or independent of an infotainment module. Audio system 56 can be used to provide directional audio awareness when a driver of the vehicle 12 should be alerted to a potential threat. Microphone 54 provides audio input to the wireless communications device 40 to enable the driver or other occupant to provide voice commands and/or carry out hands-free calling via the wireless carrier system 70. For this purpose, it can be connected to an on-board automated voice processing unit utilizing human-machine interface (HMI) technology known in the art. Visual display or touch screen 50 is preferably a graphics display and can be used to provide a multitude of input and output functions. Display 50 can be a touch screen on the instrument panel, a heads-up display reflected off of the windshield, or a projector that can project graphics for viewing by a vehicle occupant. For example, in one embodiment, the display 50 is an augmented reality display shown through the windshield of the vehicle 12. Haptic feedback device 58 can be used to provide tactile sensations to the driver of the vehicle 12. In this embodiment, the haptic feedback device 58 is a seat 90. Areas 92, 94 can be activated, for example, to alert a driver of the vehicle 12 that there is a potential threat toward the corresponding side of the vehicle. Various other vehicle-user interfaces can also be utilized, as the interfaces of FIG. 1 are only an example of one particular implementation. Accordingly, a driver of the vehicle 12 can be alerted to various potential threats using the one or more vehicle-user interfaces, as discussed more below.

The ECU 60 controls various components of the threat assessment system 10 and handles vehicle-based processing of many, if not all, of the real-time or almost-real-time processing required to carry out the methods herein. Accordingly, the ECU 60 may obtain feedback or information from numerous sources, such as the sensors 22-32 and cameras 34, 36, and then use such feedback or information to assess errant threat detection. The ECU 60 may be considered a controller, a control module, etc., and may include any variety of electronic processing devices, memory devices, input/output (I/O) devices, and/or other known components, and may perform various control and/or communication related functions. In an example embodiment, ECU 60 includes an electronic memory device 62 that stores sensor readings (e.g., sensor readings from sensors 22-32), images or video information (e.g., images or video feed from cameras 34, 36), look up tables or other data structures (e.g., look up tables relating to calibratable weights or thresholds as described below), algorithms (e.g., the algorithm embodied in the methods described below), etc. The memory device 62 may maintain a buffer consisting of data collected over a predetermined period of time or during predetermined instances (e.g., glance aim points of a driver, sensor readings, etc.). The memory device 62 or just a portion thereof, can be implemented or maintained in the form of an electronic data structure, as is understood in the art. ECU 60 also includes an electronic processing device 64 (e.g., a microprocessor, a microcontroller, an application specific integrated circuit (ASIC), etc.) that executes instructions for software, firmware, programs, algorithms, scripts, etc. that are stored in memory device 62 and may partially govern the processes and methods described herein.

Depending on the particular embodiment, the ECU 60 may be a stand-alone vehicle electronic module (e.g., a specialized or dedicated threat assessment controller), it may be incorporated or included within another vehicle electronic module (e.g., a video controller), or it may be part of a larger network or system (e.g., an active safety system), or it may be a slave control unit implementing low-level controls on the basis of a supervising vehicle control unit, to name a few possibilities. Accordingly, the ECU 60 is not limited to any one particular embodiment or arrangement and may be used by the present method to control one or more aspects of the threat assessment system 10 operation. The threat assessment system 10 and/or ECU 60 may also include a calibration file, which is a setup file that defines the commands given to actuating components such as the display 50, audio system 56, and/or haptic feedback device 58.

Wireless carrier system 70 may be any suitable cellular telephone system. Carrier system 70 is shown as including a cellular tower 72; however, the carrier system 70 may include one or more of the following components (e.g., depending on the cellular technology): cellular towers, base transceiver stations, mobile switching centers, base station controllers, evolved nodes (e.g., eNodeBs), mobility management entities (MMEs), serving and PGN gateways, etc., as well as any other networking components required to connect wireless carrier system 70 with the land network 76 or to connect the wireless carrier system with user equipment (UEs, e.g., which can include telematics equipment in vehicle 12). Carrier system 70 can implement any suitable communications technology, including GSM/GPRS technology, CDMA or CDMA2000 technology, LTE technology, etc.

Apart from using wireless carrier system 70, a different wireless carrier system in the form of satellite communication can be used to provide uni-directional or bi-directional communication with the vehicle. This can be done using one or more communication satellites (not shown) and an uplink transmitting station (not shown). Uni-directional communication can be, for example, satellite radio services, wherein programming content (news, music, etc.) is received by the uplink transmitting station, packaged for upload, and then sent to the satellite, which broadcasts the programming to subscribers. Bi-directional communication can be, for example, satellite telephony services using the one or more communication satellites to relay telephone communications between the vehicle 12 and the uplink transmitting station. If used, this satellite telephony can be utilized either in addition to or in lieu of wireless carrier system 70.

Land network 76 may be a conventional land-based telecommunications network that is connected to one or more landline telephones and connects wireless carrier system 70 to vehicle backend facility 80. For example, land network 76 may include a public switched telephone network (PSTN) such as that used to provide hardwired telephony, packet-switched data communications, and the Internet infrastructure. One or more segments of land network 76 could be implemented through the use of a standard wired network, a fiber or other optical network, a cable network, power lines, other wireless networks such as wireless local area networks (WLANs), or networks providing broadband wireless access (BWA), or any combination thereof.

Computers 78 (only one shown) can be some of a number of computers accessible via a private or public network such as the Internet. In one embodiment, each such computer 78 can be used for one or more purposes, such as for training and initial development of the predictive saliency distribution. Other such accessible computers 78 can be, for example: a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12, backend facility 80, or both. A computer 78 can also be used for providing Internet connectivity such as DNS services or as a network address server that uses DHCP or other suitable protocol to assign an IP address to vehicle 12.

Vehicle backend facility 80 is located remotely from vehicle 12. The backend facility 80 may be designed to provide the vehicle electronics 20 with a number of different system back-end functions through use of one or more electronic servers 82 and, in many cases, may provide processing capabilities for the initial training of the models described herein, while most real-time or almost-real-time processing is done at the vehicle 12, such as with ECU 60. The backend facility 80 may be a physical call center, or it could be a cloud-based server or the like. The backend facility 80 includes vehicle backend servers 82 and databases 84, which may be stored on a plurality of memory devices. Vehicle backend facility 80 may include any or all of these various components and, preferably, each of the various components are coupled to one another via a wired or wireless local area network. Backend facility 80 may receive and transmit data via a modem connected to land network 76. Data transmissions may also be conducted by wireless systems, such as IEEE 802.11x, GPRS, and the like. Those skilled in the art will appreciate that, although only one backend facility 80 and one computer 78 are depicted in the illustrated embodiment, numerous remote facilities 80 and/or computers 78 may be used. Moreover, a plurality of backend facilities 80 and/or computers 78 can be geographically distributed and can each coordinate information and services with one another.

Servers 82 can be computers or other computing devices that include at least one processor and that include memory. The processors can be any type of device capable of processing electronic instructions including microprocessors, microcontrollers, host processors, controllers, vehicle communication processors, and application specific integrated circuits (ASICs). The processors can be dedicated processors used only for servers 82 or can be shared with other systems. The at least one processor can execute various types of digitally-stored instructions, such as software or firmware, which enable the servers 82 to provide a wide variety of services. This software may be stored in computer-readable memory and can be any suitable non-transitory, computer-readable medium. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives. For network communications (e.g., intra-network communications, inter-network communications including Internet connections), the servers can include one or more network interface cards (NICs) (including wireless NICs (WNICs)) that can be used to transport data to and from the computers. These NICs can allow the one or more servers 82 to connect with one another, databases 84, or other networking devices, including routers, modems, and/or switches. In one particular embodiment, the NICs (including WNICs) of servers 82 may allow SRWC connections to be established and/or may include Ethernet (IEEE 802.3) ports to which Ethernet cables may be connected to that can provide for a data connection between two or more devices. Backend facility 80 can include a number of routers, modems, switches, or other network devices that can be used to provide networking capabilities, such as connecting with land network 76 and/or cellular carrier system 70.

Databases 84 can be stored on a plurality of memory devices, such as a powered temporary memory or any suitable non-transitory, computer-readable medium. For example, the memory can be any of a number of different types of RAM (random-access memory, including various types of dynamic RAM (DRAM) and static RAM (SRAM)), ROM (read-only memory), solid-state drives (SSDs) (including other solid-state storage such as solid state hybrid drives (SSHDs)), hard disk drives (HDDs), magnetic or optical disc drives, that stores some or all of the software needed to carry out the various external device functions discussed herein. One or more databases 84 at the backend facility 80 can store various information and can include a database for storing information relating to the development of the predictive saliency distribution.

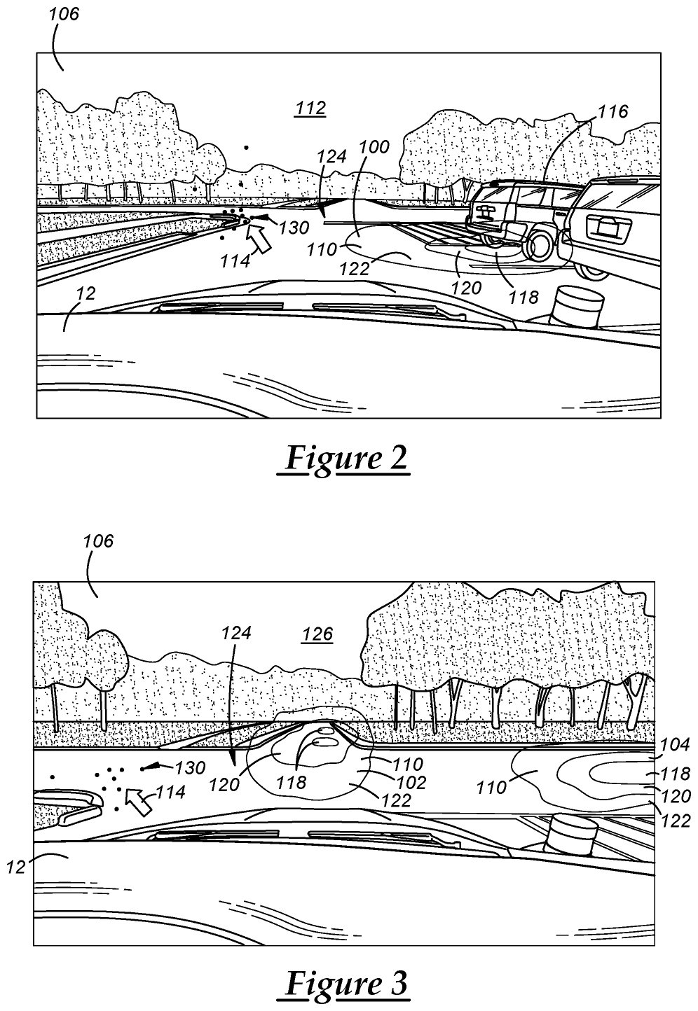

FIGS. 2 and 3 schematically illustrate various embodiments of a threat detection distribution 100, 102, 104 that may be used with the present systems and methods. FIG. 2 illustrates a view out of the windshield 106 of vehicle 12 from the threat assessment system 10 of FIG. 1. The threat detection distribution 100 is a predictive saliency distribution 110 that is overlaid on an analysis image 112 of the environment outside of the vehicle 12, such as that taken by the environmental camera 34. The predictive saliency distribution 110 is a spatiotemporal camera based predictive distribution of threats, and relating to threats, that other drivers would be likely to visually attend. The predictive saliency distribution 110 is highlighted in this example since a glance aim point estimation 114 faces away from a potential threat (i.e., object vehicle 116). Given the divergence between the predictive saliency distribution 110 and the glance aim point estimation 114, such as a glance track probability distribution obtained from the driver facing camera 36, the systems and methods may alert the driver of the vehicle 12 as to the potential threat or object vehicle 116. The predictive saliency distribution 110 has a high warning zone 118, a moderate warning zone 120, and a low warning zone 122. In some embodiments, the high warning zone 118 may be colored red or the like to represent the highest estimated risk radius, the moderate warning zone 120 may transition from red to orange or yellow to represent a moderately estimated risk radius, and the low warning zone 122 may transition to green or blue to represent a low estimated risk radius.

The predictive saliency distribution 110 is similar to a dynamic heat map or the like that changes in accordance with movement of the vehicle 12 and/or movement of objects or threats in the environment. Development of the predictive saliency distribution is described in further detail below. In the illustrations in FIGS. 2 and 3, the predictive saliency distribution 110 includes the first threat 116, and then each zone 118-122 in each of the distributions 100, 102, 104 changes or morphs as the vehicle moves toward the intersection 124, which is shown closer in FIG. 3. FIG. 3 has a new analysis image 126, which is taken at a later time than the analysis image 112 of FIG. 2. In FIG. 3, given the glance aim point estimation 114, threat detection distributions 102, 104 may indicate areas in which the driver of the vehicle 12 should attend to (e.g., the predictive saliency distributions 110). The methods described below more fully detail the development of the various distributions schematically illustrated in FIGS. 2 and 3.

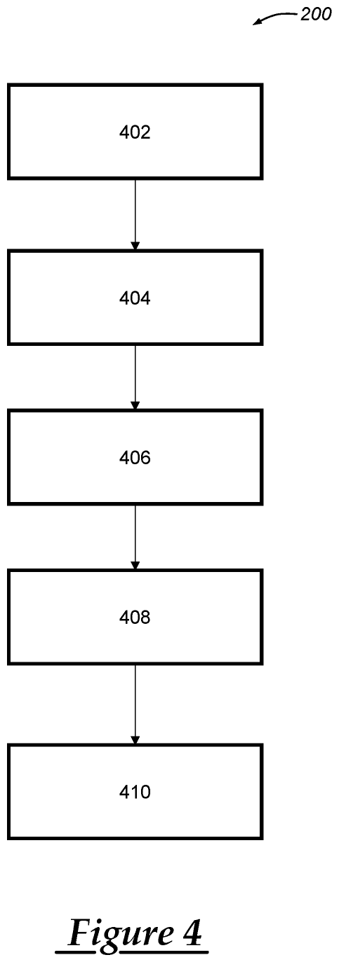

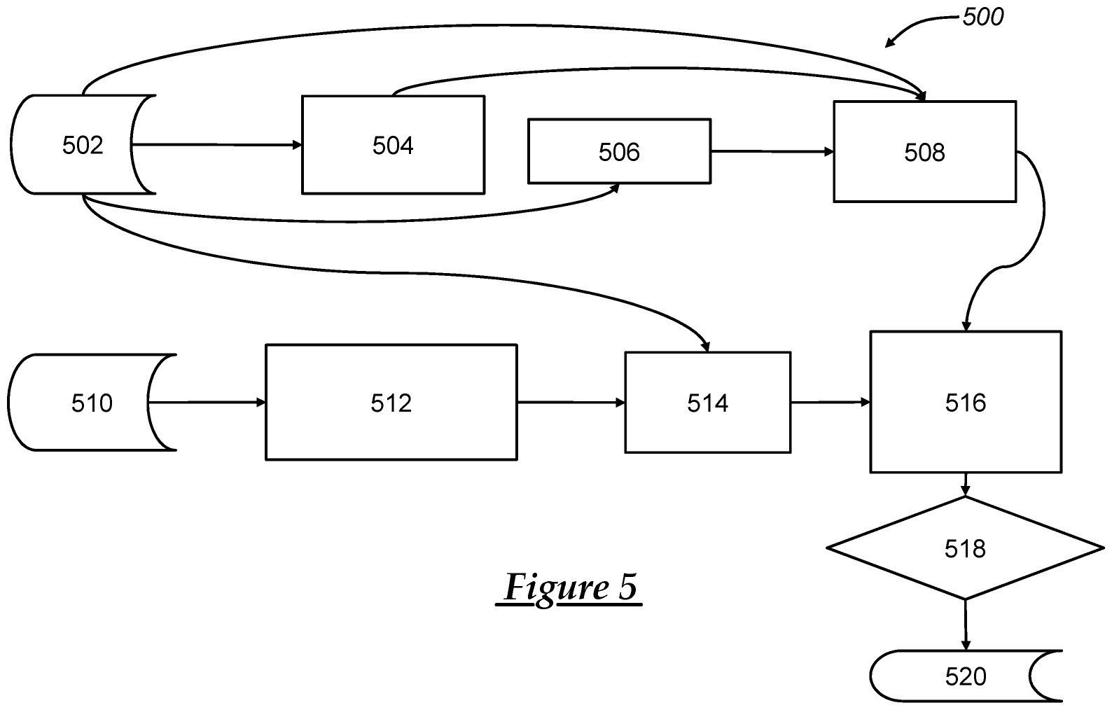

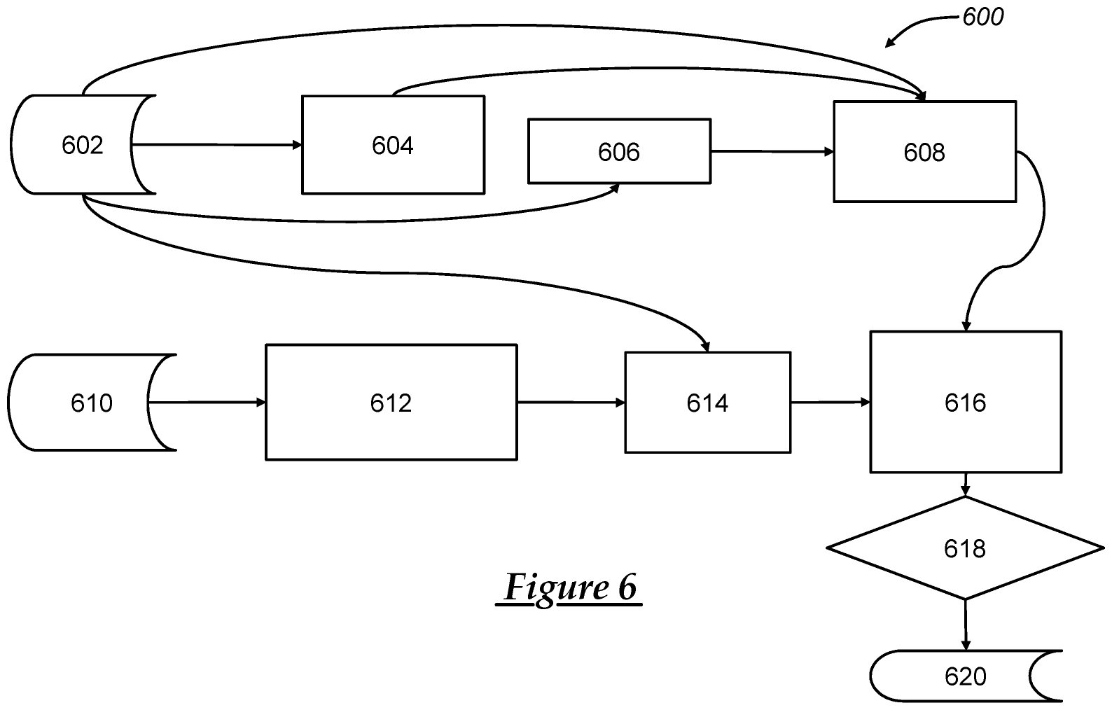

FIG. 4 illustrates a method 400, with FIGS. 5 and 6 illustrating more particular embodiments 500, 600 of the method 400, respectively. The methods 400, 500, 600 may be used for assessing errant threat detection, using the system described above with respect to FIGS. 1-3. It should be understood that the steps of each method 400, 500, 600 are not necessarily presented in any particular order and that performance of some or all of the steps in an alternative order or concurrently is possible and is contemplated. Further, it is likely that the methods 400, 500, 600 could be implemented in other systems that are different from the threat assessment system 10 illustrated in FIG. 1, and that the description of the methods 400, 500, 600 within the context of the system 10 is only an example. Additionally, it is contemplated that the methods 500, 600 be run concurrently, with the method 500 being focused on glance-saliency divergence and the method 600 being focused on sensor-saliency divergence.

FIG. 4 illustrates a more general method of assessing errant threat detection 400. Step 402 of the method 400 involves receiving a detection estimation from a driver of the vehicle 12 or an object detection sensor 32. For the detection estimation, the method 500 uses a glance aim point estimation, such as the glance aim point estimation 114 schematically illustrated in FIGS. 2 and 3; whereas the method 600 uses readings from the object detection sensor 32 as the detection estimation. These methods are detailed further below in turn. Step 404 of the method 400 involves obtaining an analysis environmental camera image from a camera, such as the environmental camera 34 of the vehicle 12. Step 406 involves generating a predictive saliency distribution based on the analysis environmental camera image, such as those illustrated in FIGS. 2 and 3, and detailed further below. Step 408 involves comparing the detection estimation received from the driver of the vehicle (e.g., via driver facing camera 36) or the object detection sensor 32 with the predictive saliency distribution generated in step 406. Step 410 involves determining a deviation between the detection estimation and the predictive saliency distribution. As described above with FIGS. 2 and 3 and detailed further below, this deviation may provide an indication that the driver or sensor is not assessing threats appropriately, and an alert can be generated. The description below focuses on the more particular implementations of the method 400, with the method 500 being more focused on the driver's glance patterns, and the method 600 being more focused on input from the object detection sensor. A bulk of the real-time and/or almost-real-time processing for the methods 400, 500, 600 happens locally at the vehicle 12, using ECU 60, for example. However, some aspects may occur remotely, such as with computers 78 and/or backend facility 80. For example, some initial training of models for generating distributions may be accomplished remote from the vehicle 12.

In both methods 500, 600, similar steps are involved to generate the predictive saliency distribution that is used in each method. As addressed above, the predictive saliency distribution is a spatiotemporal camera based predictive distribution of threats, and relating to threats, that other drivers would be likely to visually attend. In some embodiments, training to initially develop one or more aspects of the predictive saliency distribution is at least partially accomplished using computers 78 and backend facility 80, with information relating to threats a driver would likely attend to then being sent locally to the vehicle 12 for real-time or almost-real-time processing. Accordingly, the predictive saliency distribution may be developed using a look-up table, an image matching algorithm, or some other compilation of particular threats, and those threats may be weighted or otherwise ranked (e.g., vehicle backing out of parking space as with the threat vehicle 116 in FIG. 2, oncoming traffic or intersections 124 as shown in FIGS. 2 and 3, or other potential threats, including but not limited to objects or pedestrians in the road, collision risks, road features such as sharp turns, etc.). Model training can be employed to develop the compilation of threats, for example, by watching drivers and recording glance patterns at particular objects incurred while driving. If, for example, a majority of drivers would visually attend to an object or threat type, that object or threat type may be included in the compilation. Weighting and/or ranking may be accomplished using various techniques, including weighting by proximity, speed, acceleration, etc., using data obtained from the sensors 22-32, the camera 34, or some other source.

To develop the predictive saliency distribution, steps 502, 602 involve obtaining a plurality of initial environmental camera images before obtaining the analysis environmental camera image. The plurality of initial environmental camera images and the analysis environmental camera image are preferably consecutive images obtained or otherwise extracted from video feed from the environmental camera 34. The number of initial environmental camera images may depend on the batch size to be passed in a neural network, as will be detailed further below. In one advantageous embodiment, the number of initial environmental camera images is fifteen, with the sixteenth image being the analysis environmental camera image, such as the image 112 shown in FIG. 2. Once the plurality of initial environmental camera images are obtained, each analysis image may continue sequentially after the initial batch. For example, latency is not impacted with the analysis image 126 shown in FIG. 3, because a sufficient batch size has already been obtained, and subsequent processing of each individual analysis environmental image can be processed after the initial environmental camera images have been processed.

Steps 504, 604, in one particular embodiment, involve performing an optical flow analysis of the initial environmental camera images. In one embodiment, the optical flow analysis involves image matching of each of the initial environmental camera images. The optical flow analysis helps encode information relating to relative movement in the area ahead of the vehicle 12, or another area being monitored and employed with the methods 500, 600. In one particular example, OpenCV Deepflow is used in steps 504, 604. In other embodiments, variational energy minimization or another type of image matching optical flow analysis is employed.

Steps 506, 606, in one particular embodiment, involve semantic segmentation of the analysis environmental camera image. The semantic segmentation analysis may provide scenic information, and may output various regions, structures, segments, shapes etc. that are used to generate the predictive saliency distribution. The semantic segmentation may use any operable algorithm or segmentation technique, and will likely depend on the desired segmentation output structures. In some embodiments, each individual initial environmental image is also analyzed using a semantic segmentation analysis. In such an embodiment, an aggregate sequence of 16 segmented frames is input into steps 508, 608. However, alternatively numbered sequences are certainly possible (e.g., the initial batch may have more or less sequential image frames).

Steps 508, 608 involve generating the predictive saliency distribution. Steps 508, 608 take input from the analysis environmental camera image, the optical flow analysis results from steps 504, 604, and the semantic segmentation analysis results from steps 506, 606. In one embodiment, a neural network is used to generate the predictive saliency distribution, and the predictive saliency distribution is a probability distribution function indicating potential threat areas in the analysis environmental image that other drivers would likely attend to. In one example, as illustrated in FIGS. 2 and 3, the predictive saliency distribution 110 is a heat map that dynamically highlights various zones in the sequential images, with the distribution 110 changing or morphing as the relative positions of various threats in the images change. The predictive saliency distribution 110 can also be represented in other various forms, such as numerically, graphically, or using another distribution function model.

Both methods 500, 600 use the predictive saliency distribution generated in steps 502-508 and 602-608, respectively, as input. The methods 500, 600 vary in that, in addition to the predictive saliency distribution, a glance aim point estimation (method 500: steps 510-512) and a threat weighted occupancy probability distribution (method 600: steps 610-612) are used as inputs. Accordingly, the method 500 is more glance-saliency focused while the method 600 is more sensor-saliency focused.

Step 510 of the method 500 involves receiving eye tracking data from the driver of the vehicle. This may be accomplished using the driver facing camera 36. In some embodiments, the eye tracking data may represent several X,Y coordinates. This can be estimated or projected to the scene ahead of the vehicle 12, as schematically illustrated by the dots 130 in FIGS. 2 and 3. A glance aim point estimation can be obtained by analyzing several frames from the driver facing camera video. In some embodiments, the frame rate for the driver facing camera 36 (e.g., about every 1/10 of a second) is higher than the frame rate for the environmental camera 34 so that more data for the glance aim point estimation can be achieved.

Step 512 of the method 500 involves determining a glance track probability distribution using the eye tracking data from step 510. The glance track probability distribution is a glance aim point estimation that can represent clusters or groups of coordinated eye movements (e.g., a model distribution over the scene). In one embodiment, a 2D hidden Markov model (HMM) is used to determine the glance track probability distribution from the received eye tracking data. The 2D HMI may be advantageous model given the sequence-based image analysis.

Step 514 of the method 500 involves creating a homographic projection to reconcile the glance track probability distribution and the analysis environmental camera image. The homographic projection accordingly reconciles the input from the environmental camera 34 and the driver facing camera 36. The processing attributes and algorithms involved in creating the homographic projection will depend on various factors, such as the mounting arrangement of each of the cameras 34, 36, the type of cameras, the sizes of the images, etc. Creating the homographic projection in step 514 allows for a more efficient and accurate comparison with the predictive saliency distribution calculated in step 508.

Step 516 involves determining a glance-saliency divergence between the predictive saliency distribution determined in steps 502-508 and the glance track probability distribution determined in steps 510-514. The larger the divergence, the more likely that a driver is not paying attention to a salient threat to the vehicle 12. In an advantageous embodiment, step 516 involves calculating the Kullback-Leibler (KL) divergence between the predictive saliency distribution and the glance track probability distribution. Combining the KL divergence (the glance-saliency divergence) with the neural network for the predictive saliency distribution can allow for more complex approximating and more accurate determinations of errant threat detection. Other methods of determining the divergence in step 516 include, but are not limited to, scan salience, histogram analysis, pixel linearity, analyzing the area under a ROC (receiver operating characteristic) curve, or some other operable method.

Step 518 of the method 500 involves comparing the glance-saliency divergence determined in step 516 to a glance-saliency divergence threshold. In one embodiment, step 518 asks whether the glance-saliency divergence is greater than a glance-saliency divergence threshold. It should be understood that recitations of comparing steps such as “less than” or “greater than” are open-ended such that they could include “less than or equal to” or “greater than or equal to,” respectively, and this will depend on the established parameter evaluations in the desired implementation. The glance-saliency divergence threshold can be a dynamic threshold that is at least partially learned from or based on prior data. In one more particular embodiment, the glance-saliency divergence threshold is a heuristically learned threshold that is at least partially based on the current salience and/or glance pattern. For example, if the predictive saliency distribution indicates a possible threat toward the periphery (e.g., approaching traffic from a side street), but the driver is looking to the center, the threshold may be lower. In contrast, there is a central bias for drivers to stare toward the horizon. If the predictive saliency distribution indicates a potential threat on the highway ahead of the vehicle while the driver is looking at a peripheral region, the threshold may be higher. Accordingly, the glance-saliency threshold may be adaptable depending on the type of threat, the position of the driver's glance given the driving environment, or other factors. Advantageously, the glance-saliency threshold is developed such that a high probability saliency prediction (e.g., zones 118, 120 in the predictive saliency distribution 110) with a low probability glance aim point estimation, will trigger the system 10 to alert the driver of the vehicle 12.

Step 520 of the method 500 involves alerting the driver of the vehicle 12 if the glance-saliency divergence is greater than the glance-saliency divergence threshold. In such a situation, the driver may be distracted, tired, or non-attentive. Various alerts can be provided, such as with display 50. In an advantageous embodiment, the display 50 is an augmented reality display that highlights or provides some sort of visual indication to the driver that attention should be focused elsewhere (e.g., a potential threat is highlighted on the augmented reality display or another display in the vehicle 12). In another embodiment, a directional audio cue is provided using audio system 56. For example, acoustical cues may be provided for directional audio awareness to help indicate where a driver should be paying attention. In yet another embodiment, a haptic feedback device 58 is used to alert the driver. For example, areas 92, 94 in the seat 90 can be activated to alert a driver of the vehicle 12 that there is a potential threat toward the corresponding side of the vehicle. Other HMI-based alerts are certainly possible, as well as various other alerts. For example, an autonomous driving action or the like may be performed to help avoid the threat.

As described above, both methods 500, 600 use the predictive saliency distribution generated in steps 502-508 and 602-608, respectively, as input. The method 600 in FIG. 6 varies from the method 500 in FIG. 5, in that the method 600 uses a threat weighted occupancy probability distribution (method 600: steps 610-612) as input instead of the glance aim point estimation (method 500: steps 510-512).

Step 610 of the method 600 involves receiving external sensor readings. This may be accomplished using the object detection sensor 32, which is advantageously a radar sensor or a lidar sensor. In a more particular embodiment, the sensor readings received in step 610 are object detection readings from a penetrating radar sensor. The representation of information from the sensor readings can be provided in a number of different operable forms. For example, a Markov random field (MRF) model can be used to estimate an occupancy grid, using sensor readings from object detection sensor 32 that can be filtered and/or smoothed.

Step 612 of the method 600 involves determining a threat weighted occupancy probability distribution from one or more of the sensor readings obtained in step 610. Continuing with the example provided above, the occupancy grid can be used to at least partially determine the threat weighted occupancy probability distribution. The occupancy grid can be developed using an MRF model, which each grid cell generally representing a location of the threat, with one or more aspects such as inertia, relative velocity, etc. being represented in a different dimension (e.g., along the Z-axis with location being designated via X, Y coordinates, with some embodiments possibly having three or more dimensions). Accordingly, in this embodiment, the occupancy grid is the threat weighted occupancy probability distribution; however, other methods for generating the threat weighted occupancy probability distribution are certainly possible. For example, sensor data may be provided in different coordinate schemes or in other formats that are more suitable for different distribution types. Additionally, step 612 may use information such as host vehicle speed as indicated by readings from speed sensors 22-28, or information from other system components, to help generate the threat weighted occupancy probability distribution.

Step 614 of the method 600 involves creating an alignment projection to reconcile the threat weighted occupancy probability distribution and the analysis environmental camera image obtained in step 602. In one embodiment, the alignment projection is a homographic projection, although other alignment techniques are possible and may depend on the type of sensor 32. The alignment projection accordingly reconciles the input from the environmental camera 34 and the object detection sensor 32. The processing attributes and algorithms involved in creating the projection will depend on various factors, such as the mounting arrangement of the camera 34, the type of sensor 32, the size of the images, the range of the sensor 32, etc. Creating the alignment projection in step 614 allows for a more efficient and accurate comparison with the predictive saliency distribution calculated in step 608.

Step 616 involves determining a sensor-saliency divergence between the predictive saliency distribution determined in steps 602-608 and the threat weighted occupancy probability distribution determined in steps 610-614. The larger the divergence, the more likely that there are anomalous environmental sensor indications. In some instances, the object detection sensor 32 may indicate out of the ordinary objects or maneuvers not triggered or rendered risky with the predictive saliency distribution. These anomalies could help with training or developing the predictive saliency distribution, alerting a driver as to misaligned sensors (e.g., with a high probability saliency prediction and a low probability threat weighted occupancy detection), and/or alerting a driver as to a low probability salient threat (e.g., one that most drivers would not assess) yet is still risky as indicated by a high probability threat weighted occupancy detection. In an advantageous embodiment, step 616 involves calculating the Kullback-Leibler (KL) divergence between the predictive saliency distribution and the threat weighted occupancy probability distribution. Combining the KL divergence (the sensor-saliency divergence) with the neural network for the predictive saliency distribution can allow for more complex approximating and more accurate determinations of errant threat detection. Other methods of determining the divergence in step 616 include, but are not limited to, scan salience, histogram analysis, pixel linearity, analyzing the area under a ROC (receiver operating characteristic) curve, or some other operable method.

Step 618 of the method 600 involves comparing the sensor-saliency divergence determined in step 616 to a sensor-saliency divergence threshold. In one embodiment, step 618 asks whether the sensor-saliency divergence is greater than a sensor-saliency divergence threshold. Again, it should be understood that recitations of comparing steps such as “less than” or “greater than” are open-ended such that they could include “less than or equal to” or “greater than or equal to,” respectively, and this will depend on the established parameter evaluations in the desired implementation. As with the glance-saliency divergence threshold, the sensor-saliency divergence threshold can be a dynamic threshold that is at least partially learned from or based on prior data. In one more particular embodiment, the sensor-saliency divergence threshold is a heuristically learned threshold that is at least partially based on the current salience and/or sensor readings. For example, if a penetrating radar object detection sensor 32 indicates a biker is approaching the vehicle from behind a hedge on the side of the vehicle 12, yet the predictive saliency distribution indicates no risk, the threshold could be lower. The threshold may be higher for more salient threats directly ahead of the vehicle. Accordingly, the sensor-saliency threshold may be adaptable depending on the type of threat, the type of sensor, or other factors. Advantageously, the sensor-saliency threshold is developed such that a low probability saliency prediction (e.g., zone 122 or no zone in the predictive saliency distribution 110) with a high probability threat weighted occupancy estimation, will trigger the system 10 to alert the driver of the vehicle 12.

Step 620 of the method 600 involves alerting the driver of the vehicle 12 if the sensor-saliency divergence is greater than the sensor-saliency divergence threshold. In such a situation, there may be a risk to the driver that is not readily salient. Various alerts can be provided, such as with display 50. In an advantageous embodiment, the display 50 is an augmented reality display that highlights or provides some sort of visual indication to the driver that attention should be focused on the threat detected by the object detection sensor 32 (e.g., a potential threat is highlighted on the augmented reality display or another display in the vehicle 12). In another embodiment, a directional audio cue is provided using audio system 56. For example, acoustical cues may be provided for directional audio awareness to help indicate where the detected threat is generally located. In yet another embodiment, a haptic feedback device 58 is used to alert the driver. For example, areas 92, 94 in the seat 90 can be activated to alert a driver of the vehicle 12 that there is a potential threat toward the corresponding side of the vehicle. Other HMI-based alerts are certainly possible, as well as various other alerts. For example, an autonomous driving action or the like may be performed to help avoid the threat.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims. As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering any one or more of the following: “A”; “B”; “C”; “A and B”; “A and C”; “B and C”; and “A, B, and C.”

What is claimed is:

1. A method of assessing errant threat detection for a vehicle, comprising the steps of:
receiving a detection estimation from a driver of the vehicle or an object detection sensor of the vehicle;
obtaining an analysis environmental camera image from a camera on the vehicle;
generating a predictive saliency distribution based on the analysis environmental camera image;
comparing the detection estimation received from the driver of the vehicle or the object detection sensor of the vehicle with the predictive saliency distribution; and
determining a deviation between the detection estimation and the predictive saliency distribution.

2. The method of claim 1, wherein the predictive saliency distribution is a spatiotemporal camera based predictive distribution of threats, and relating to threats, that other drivers would be likely to visually attend.

3. The method of claim 2, further comprising the step of obtaining a plurality of initial environmental camera images before the analysis environmental camera image.

4. The method of claim 3, further comprising the step of performing an optical flow analysis of the plurality of initial environmental images and using results of the optical flow analysis to generate the predictive saliency distribution.

5. The method of claim 4, further comprising the step of performing a semantic segmentation of the analysis environmental camera image and using both the results of the optical flow analysis and the semantic segmentation to generate the predictive saliency distribution.

6. The method of claim 1, wherein the detection estimation is a glance aim point estimation received from a driver of the vehicle.

7. The method of claim 6, wherein the glance aim point estimation involves determining a glance track probability distribution.

8. The method of claim 7, wherein a 2D hidden Markov model (HMM) is used to determine the glance track probability distribution.

9. The method of claim 7, further comprising the step of creating a homographic projection to reconcile the glance track probability distribution and the analysis environmental camera image.

10. The method of claim 7, wherein the divergence is a glance-saliency divergence between the glance track probability distribution and the predictive salience distribution.

11. The method of claim 10, further comprising the step of comparing the glance-saliency divergence to a glance-saliency divergence threshold and alerting the driver if the glance-saliency divergence is greater than the glance-saliency divergence threshold.

12. The method of claim 1, wherein the detection estimation is a threat weighted occupancy probability distribution from one or more sensor readings from the object detection sensor of the vehicle.

13. The method of claim 12, wherein the object detection sensor is a radar sensor or a lidar sensor.

14. The method of claim 12, further comprising the step of using a Markov random field model to estimate an occupancy grid to develop the threat weighted occupancy probability distribution.

15. The method of claim 12, further comprising the step of creating a homographic projection to reconcile the threat weighted occupancy probability distribution and the analysis environmental camera image.

16. The method of claim 12, wherein the divergence is a sensor-saliency divergence between the threat weighted occupancy probability distribution and the predictive salience distribution.

17. The method of claim 16, further comprising the step of comparing the sensor-saliency divergence to a sensor-saliency divergence threshold and alerting the driver if the sensor-saliency divergence is greater than the sensor-saliency divergence threshold.

18. A method of assessing errant threat detection for a vehicle, comprising the steps of:
determining a glance track probability distribution to estimate a glance aim point of a driver of the vehicle;
obtaining an analysis environmental camera image from a camera on the vehicle;
determining a glance-saliency divergence between a predictive saliency distribution that corresponds with the analysis environmental camera image and the glance track probability distribution;
comparing the glance-saliency divergence to a glance-saliency divergence threshold; and
alerting the driver if the glance-saliency divergence is greater than the glance-saliency divergence threshold.

19. A threat assessment system for a vehicle, comprising:
a camera module;
an object detection sensor; and
an electronic control unit (ECU) operably coupled to the camera module and the object detection sensor, wherein the ECU is configured to receive a detection estimation from a driver of the vehicle or the object detection sensor, obtain an analysis environmental camera image from the camera module, generate a predictive saliency distribution based on the analysis environmental camera image; compare the detection estimation received from the driver of the vehicle or the object detection sensor with the predictive saliency distribution, and determine a deviation between the detection estimation and the predictive saliency distribution.

20. The system of claim 19, wherein the camera module includes a driver facing camera and an environmental camera.
